(19) United States
(12) Patent Application Publication
(10) Pub. No.: US 2011/0264925 A1
(43) Pub. Date: Oct. 27, 2011

(54) SECURING DATA ON A SELF-ENCRYPTING STORAGE DEVICE

(76) Inventors: Leonard E. Russo, Tomball, TX (US); Valiuddin Ali, Cypress, TX (US); Jennifer Rios, Spring, TX (US); Lan Wang, Cypress, TX (US)

(21) Appl. No.: 12/766,223

(22) Filed: Apr. 23, 2010

(51) Int. Cl. G06F 12/14; H04L 9/00

(52) U.S. Cl. 713/193; 711/163; 380/277; 711/E12.001; 711/E12.092

(57) ABSTRACT

Disclosed embodiments relate to a method for securing data on a self-encrypting storage device. The method may comprise, for example, receiving, by a self-encrypting storage device, information indicating a procedure for securing data stored on the self-encrypting storage device and selecting, by the self-encrypting storage device, a procedure for securing data stored on the self-encrypting storage device based on the received information. The procedure may comprise replacing data stored on the self-encrypting storage device or deleting a decryption key associated with data stored on the self-encrypting storage device. In one embodiment, the method further involves performing, by the self-encrypting storage device, the selected procedure.

### BACKGROUND

Electronic devices are often used to store sensitive data. For example, a notebook computer may be used for storing proprietary business information or personal information. The data may be stored, for example, on a self-encrypting storage device. In order to protect sensitive information, it may be desirable to secure the data to make it inaccessible to future users of the electronic device. Securing data may be useful in the event of an electronic device being stolen or in the case of an electronic device being transferred to a new user.

### BRIEF DESCRIPTION OF THE DRAWINGS

In the accompanying drawings, like numerals refer to like components or blocks. The following detailed description references the drawings, wherein:

FIG. 1 is a block diagram illustrating one embodiment of a computing system.

FIG. 2 is a flow chart illustrating one embodiment of a method for securing data stored on a self-encrypting storage device.

FIG. 3 is a block diagram illustrating one embodiment of securing data stored on a self-encrypting storage device.

### DETAILED DESCRIPTION

Data may be stored on a storage device associated with an electronic device. In some circumstances, a user may want to secure the data so that future users may not gain access to sensitive information. For example, an employer may wish to erase data from an employee's computer so that the employee no longer has access to it. As another example, a user may erase data on an electronic device before selling it.

Sensitive data may be stored on a self-encrypting storage device, such as a self-encrypting hard disk drive. A self-encrypting storage device may include processing capabilities for encrypting data stored on the self-encrypting storage device. In some implementations, the self-encrypting storage device may also store a decryption key associated with encrypted data stored on the self-encrypting storage device. A self-encrypting storage device may be in some cases more difficult to interfere with and simpler to implement than, for example, a host computer executing a software program to encrypt data and store it on a storage device.

A self-encrypting storage device may secure data stored on it. For example, the Advanced Technology Attachment (ATA) specification allows a host electronic device to send an instruction to secure data to a self-encrypting storage device. The self-encrypting storage device may then respond to the command by replacing data stored on the self-encrypting storage device with 1's or 0's. Methods for securing information on a self-encrypting storage device, however, may fail to provide a user control over the process. For example, a self-encrypting storage device may be in some cases limited to one type of procedure for securing data stored on it.

In one embodiment, a self-encrypting storage device provides for multiple procedures for securing data stored on the self-encrypting storage device. For example, a self-encrypting storage device may receive an instruction indicating a procedure to be used to secure data. The methods for securing data may include replacing data, such as with 1's or 0's, or deleting a decryption key associated with encrypted data stored on the self-encrypting storage device. In some cases, an end user may select one of the available procedures for securing data. In one embodiment, an electronic device in communication with a self-encrypting storage device selects a method for securing data on the self-encrypting storage device based on factors such as the amount of data stored on the self-encrypting storage device.

Disclosed embodiments for securing data on a self-encrypting storage device provide advantages. It may be desirable for a method of securing data on a self-encrypting storage device to be tailored to the particular circumstances, such as the desired speed or level of security. For example, replacing data may provide a secure method of erasing data, but such a method may be time consuming in some circumstances, such as if there is a large amount of data to be replaced. Deleting a decryption key associated with encrypted data may be performed more quickly, but in some cases it may not provide the desired level of security. A self-encrypting storage device that supports multiple methods for securing data may allow a user to select a method better suited to the user's goals or allow an electronic device to select a method based on its analysis of relevant factors, thereby, resulting in a data securing procedure better tailored to the particular context.

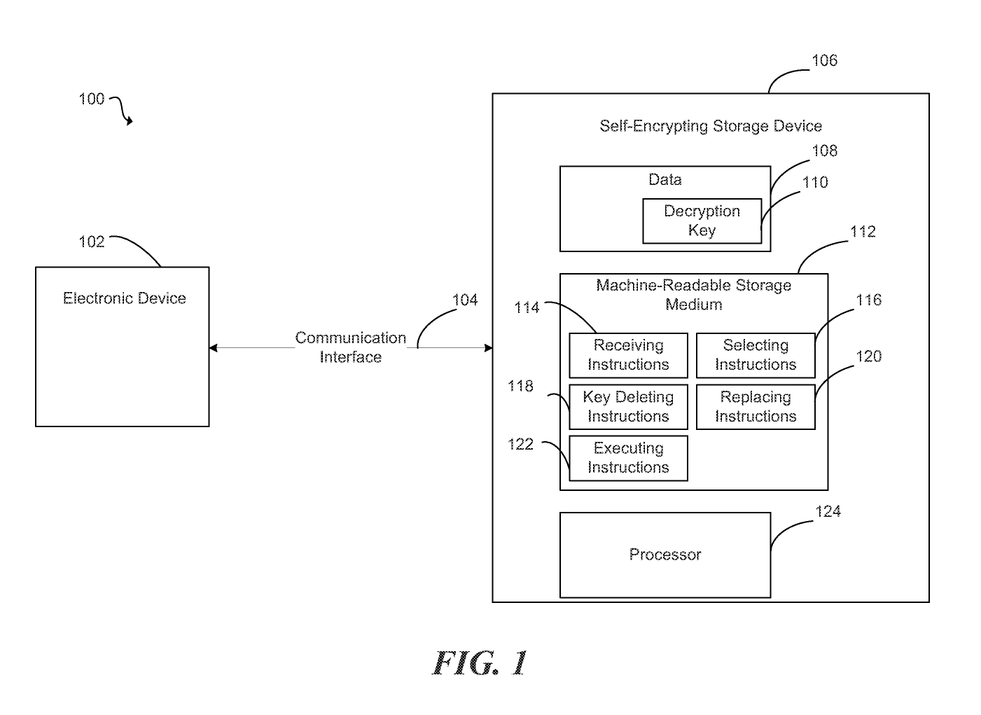

FIG. 1 is a block diagram illustrating one embodiment of a computing system 100. The computing system 100 may include an electronic device 102, a communication interface 104, and a self-encrypting storage device 106. The electronic device 102 may be any suitable electronic device, such as a desktop computer, notebook computer, server, or mobile phone.

The communication interface 104 may be, for example, a communication interface suitable for communicating between a host, such as the electronic device 102, and a storage device, such as the self-encrypting storage device 106. The communication interface 104 may be any suitable communication interface, such as an Advanced Technology Attachment (ATA), Serial Attached SCIS (SAS), Fibre Channel, Peripheral Component Interconnect Express (PCI Express), Universal Serial Bus (USB), FireWire, or Serial Advanced Technology Attachment (SATA) interface. The communication interface 104 may allow the electronic device 102 to communicate with the self-encrypting storage device 106. For example, the electronic device 102 may transmit information to the self-encrypting storage device 106 via the communication interface 104.

The self-encrypting storage device 106 may be any suitable type of self-encrypting storage device, such as a self-encrypting hard disk drive. The self-encrypting storage device 106 may be a volatile or non-volatile storage. The self-encrypting storage device 106 may include, for example, data 108, a machine-readable storage medium 112, and a processor 124. The data 108 may be any type of data. In one embodiment, the data 108 is encrypted data. For example, the data 108 may have a decryption key 110 associated with it that may be used for decrypting the data 108. The decryption key 110 may be any type of decryption key, such as a private key associated with a decryption algorithm. In some cases, the decryption key 110 may be the same key used to encrypt the data 108. In one embodiment, the decryption key 110 is stored separately from the data 108.

The processor 124 may be any suitable type of processor. For example, the processor 124 may be a central processing unit (CPU), a semiconductor-based microprocessor, or any other hardware device suitable for retrieval and execution of instructions stored in the machine-readable storage medium 112. In one embodiment, the self-encrypting storage device 106 includes logic instead of or in addition to the processor 124. In one embodiment, the processor 124 encrypts the data 108 stored on the self-encrypting storage device 106.

The machine-readable storage medium 112 may be any storage medium containing executable instructions, for example, instructions executable by the self-encrypting storage device 106, such as by the processor 124. The machine-readable storage medium 112 may be any electronic, magnetic, optical, or other physical storage device that stores executable instructions or other data (e.g., a hard disk drive, random access storage, flash storage, microcontroller storage, etc.). The machine-readable storage medium 112 may include instructions related to methods for securing the self-encrypting storage device 106, such as key deleting instructions 118 for deleting the decryption key 110 and replacing instructions 120 for replacing the data stored in data 108. In one embodiment, the machine-readable-storage medium 112 includes receiving instructions 114 for receiving information indicating a method for securing the self-encrypting storage device 106, selecting instructions 116 for selecting a method for securing the self-encrypting storage device 106 based on the received information, and executing instructions 122 for performing the selected method for securing the self-encrypting storage device.

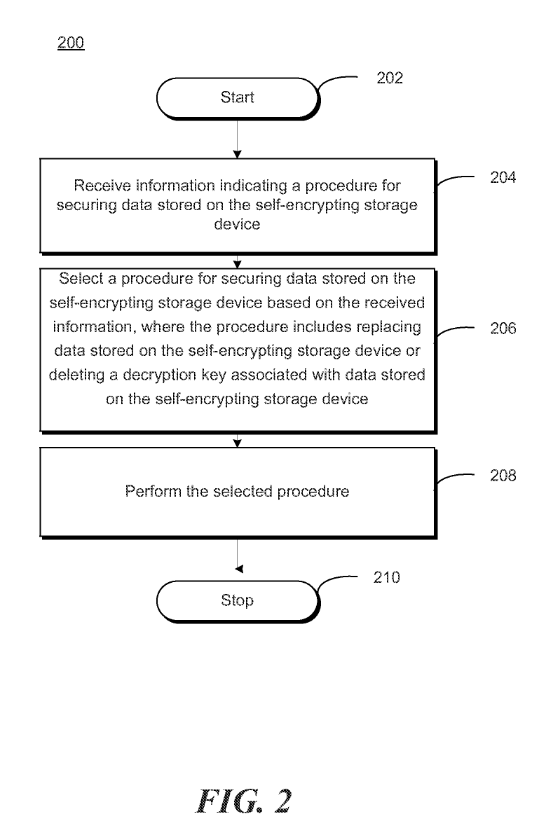

FIG. 2 is a flow chart illustrating one embodiment of a method 200 for securing the data 108 stored on the self-encrypting storage device 106. In one embodiment, the electronic device 102 sends information to the self-encrypting storage device 106, for example via the communication interface 104, indicating a method for securing the data 108. The self-encrypting storage device 106 may select a procedure for securing the data 108 based on the information received from the electronic device 102 and execute the selected method.

Beginning at block 202 and continuing to block 204, self-encrypting storage device 106 receives information indicating a procedure for securing data stored on the self-encrypting storage device 106. For example, the electronic device 102 may send information to the self-encrypting storage device 106 via the communication interface 104. The self-encrypting storage device 106, for example by executing the receiving instructions 114, may receive and process the information.

In some cases, the information received by the self-encrypting storage device 106 reflects a user's selection of a procedure for securing the data 108. For example, the electronic device 102 may include an input device for receiving a user selection that the electronic device 102 then transmits to the self-encrypting storage device 106. A user may select a method of securing the data 108 based on factors such as time and security considerations. For example, a user may select to delete a decryption key 110 associated with the data 108 when the user would like the data 108 to be secured quickly. A user may in some cases select to replace data if time is not an issue, or there is a concern that the decryption key 110 may be reconstructed or relocated elsewhere.

In some implementations, the electronic device 102 selects a method for securing the self-encrypting storage device 106. For example, the electronic device 102 may analyze a group of factors and select a method for securing the self-encrypting storage device 106 based on the analysis. The electronic device 102 may in some cases include a default setting for the procedure for securing the data 108 that may be overridden, for example, by the electronic device 102 or a user. In one embodiment, the received information is based on both user input and analysis provided by the electronic device 102.

The received information may be any information capable of indicating a method for securing the self-encrypting storage device 106. In one implementation, a pair of identifiers is used to indicate a method for securing the data 108, such as a first identifier indicating that data is to be secured and a second identifier indicating which method is to be used for securing the data 108. For example, the information may be a pair of bits.

In one embodiment, data may be received using an existing framework, such as an existing communication interface specification. In one embodiment, the information may be received in a register containing information associated with sections or sectors on the self-encrypting storage device 106. The register may be a Sector Count register, such as a Sector Count register associated with the Advanced Technology Attachment (ATA) interface. In one embodiment, the electronic device 102 may send information indicating a method for securing the data 108 in conjunction with a command for securing the self-encrypting storage device 106, such as the Advanced Technology Attachment (ATA) Secure Erase Unit command. Using an existing framework may in some cases allow a system with multiple methods for securing data to be more easily implemented.

In one embodiment, a selection of a method for securing the self-encrypting storage device 106 is wirelessly received by the electronic device 102. For example, a remote user may determine that the electronic device 102 should secure its data, such as in response to a theft of the electronic device 102. The electronic device 102 may then instruct the self-encrypting storage device 106, such as by sending a command via the communication interface 104, to secure the data 108.

Continuing to block 206, the self-encrypting storage device 106, such as by executing the selecting instructions 118, selects a procedure for securing data stored on the self-encrypting storage device 106 based on the received information. The procedure may include, for example, replacing the data 108 stored on the self-encrypting storage device 106 or deleting the decryption key 110 associated with the data 108 stored on the self-encrypting storage device 106. For example, the processor 124 may interpret the information received from the electronic device 102 to determine a method for securing the data 102. The processor 124 may select from multiple types of data securing instructions stored on the machine-readable storage medium 112, such as the key deleting instructions 118 and the replacing instructions 120. In some cases, the processor 124 may select a portion of the data 108 to secure.

The processor 124 may use any suitable method for selecting a method for securing the data 108. In one implementation, the processor 124 receives two identifiers, such as a first identifier indicating whether the data 108 is to be secured and a second identifier indicating a method for securing the data 108. For example, the processor 124 may receive in a first position, such as bit 0 in a sector register, a bit indicating that the data 108 is to be secured. A second bit, such as a bit in position 1 in a sector register, may indicate whether data is to be replaced or a decryption key is to be deleted. For example, a 0 in a first position may indicate that data should be secured, a 0 in a second position may indicate that data should be replaced, and a 1 in a second position may indicate that a decryption key should be deleted. If the processor 124 receives 00, the processor 124 may determine that the data 108 should be secured and that the selected method involves replacing the data 108 with 1's or 0's. If the processor 214 receives 01, the processor 124 may determine that the data 108 should be secured and that the selected method involves deleting the decryption key 110.

Continuing to block 208, the self-encrypting storage device 106 performs the selected procedure, such as by executing the executing instructions 122. For example, the processor 124 may delete the decryption key 110 or replace the data 108. In one embodiment, the processor 124 executes instructions related to the selected method, such as the key deleting instructions 118 or the replacing instructions 120.

In one embodiment, the key deleting instructions 118 provide instructions for deleting the decryption key 110 associated with encrypted data 108. The decryption key 110 may be deleted by any suitable means, such as replacing it with other data or reallocating the memory associated with it. If the data 108 is encrypted and there is no decryption key available for decrypting the data, then the data 108 may become inaccessible.

In one embodiment, the processor 124 selects to replace the data 108 and performs the selected procedure by executing the replacing instructions 120. Replacing instructions 120 may include instructions for replacing the data 108. For example, the data 108 may be replaced with 1's, 0's, or a combination of 1's and 0's. In some implementations, the self-encrypting storage device 106 receives information indicating what type of data to use to replace the data 108.

In some embodiments, multiple methods for securing the data 108 may be performed. For example, the processor 124 may initially delete the decryption key 110. Once the decryption key 110 is deleted, the processor 124 may replace the data 108, such as to ensure greater security. The method 200 then continues to block 210 and stops.

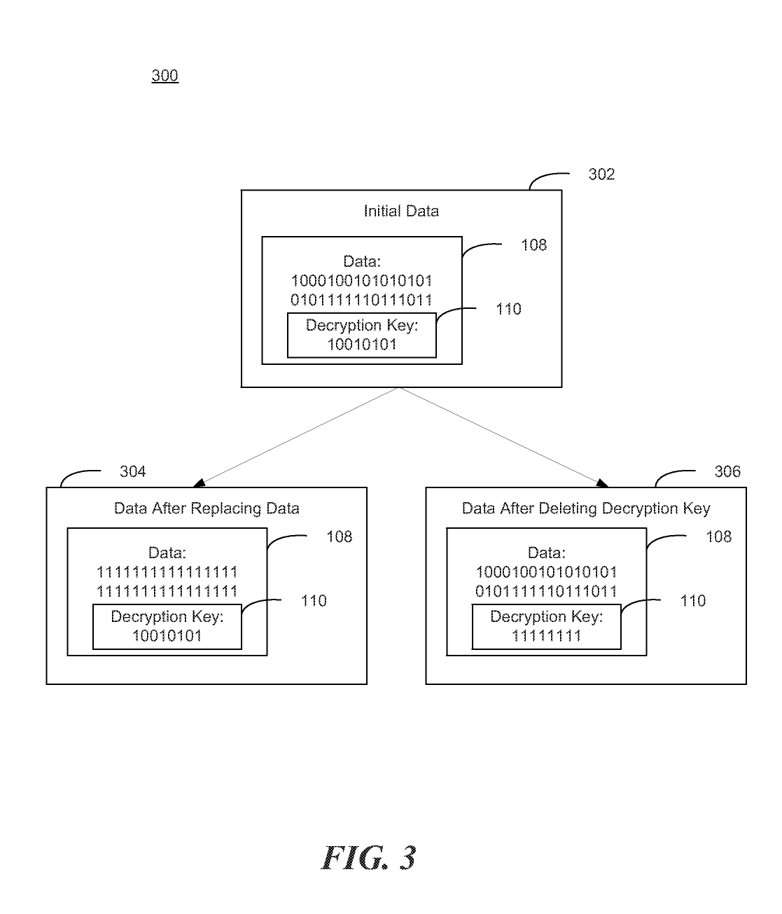

FIG. 3 is a block diagram 300 illustrating one embodiment of securing the data 108 by either replacing the data 108 or deleting the decryption key 110. Block 302 shows the data 108 prior to the processor 124 receiving a signal indicating a method for securing the data 108. The data 108 includes encrypted data and a decryption key 110.

The self-encrypting storage device 106 may receive information from the electronic device 102 indicating a procedure for securing the data 108. In some cases, the processor 124 may replace the data 108 with 1's or 0's in response to the received information. Block 304 illustrates the data 108 after the processor 124 replaces the data. For example, block 304 shows the data replaced with 1's. In one embodiment, the decryption key 110 is also replaced when the processor 124 replaces the data 108.

In one embodiment, the self-encrypting storage device 106 receives information indicating that a decryption key associated with encrypted data should be deleted. After receiving the information from the electronic device 102, the processor 124 may delete the decryption key 110 associated with the data 108. Block 306 illustrates the data 108 after the processor 124 deletes the decryption key 110. For example, block 306 shows the decryption key 110 replaced with 1's, but the remaining encrypted data 108 is the same as in block 302.

Embodiments discussed above provide advantages. Providing multiple methods for securing data on a self-encrypting storage device may allow a self-encrypting storage device to be secured in a manner tailored to the particular circumstances. For example, some specifications may provide for data being replaced to meet security standards. If there is a large amount of data, however, it may in some cases be a time consuming process to replace the data. Deleting a decryption key, on the other hand, may in some cases be performed relatively quickly. Allowing a user to select a method for securing data may result in data being secured in a manner that is more appropriate in the particular context. In addition, embodiments using an existing command structure, such as by updating an existing communication interface specification, may allow a self-encrypting storage device providing for multiple methods for securing data to be more easily incorporated into an electronic device.

1. A computing device, comprising:
a communication interface;
a self-encrypting storage device for storing data; and
a processor configured to send information indicative of a method for securing data to the self-encrypting storage device via the communication interface,
wherein the self-encrypting storage device is configured to determine a method for securing data stored on the self-encrypting storage device based on the information sent by the processor.

2. The computing device of claim 1, wherein the communication interface comprises an Advanced Technology Attachment interface.

3. The computing device of claim 1, wherein the processor is configured to send the information indicative of a method for securing data in a sector register.

4. The computing device of claim 1, wherein a method for securing data stored on the self-encrypting storage device comprises a method for replacing data stored on the self-encrypting storage device.

5. The computing device of claim 1, wherein a method for securing data stored on the self-encrypting storage device comprises a method for deleting a decryption key associated with data stored on the self-encrypting storage device.

6. A method for securing data on a self-encrypting storage device, comprising:
receiving, by a self-encrypting storage device, information indicating a procedure for securing data stored on the self-encrypting storage device;
selecting, by the self-encrypting storage device, a procedure for securing data stored on the self-encrypting storage device based on the received information,
wherein the procedure comprises replacing data stored on the self-encrypting storage device or deleting a decryption key associated with data stored on the self-encrypting storage device; and
performing, by the self-encrypting storage device, the selected procedure.

7. The method of claim 6, wherein the information is received via a communication interface.

8. The method of claim 7, wherein the communication interface comprises an Advanced Technology Attachment interface.

9. The method of claim 6, wherein the received information comprises information received in a sector register.

10. The method of claim 6, wherein the received information comprises
information indicating that data stored on the self-encrypting storage device should be secured; and
information indicating a procedure for securing data stored on the self-encrypting storage device.

11. A machine-readable storage medium encoded with instructions executable by a self-encrypting storage device, the machine-readable storage medium comprising:
instructions for a method for securing data by replacing data stored on a self-encrypting storage device; and
instructions for a method for securing data by deleting a decryption key associated with data stored on the self-encrypting storage device;
instructions for receiving information indicative of a method for securing data;
instructions for determining, based on the received information, a method for securing data stored on the self-encrypting storage device; and
instructions for executing the instructions associated with the selected method.

12. The machine-readable storage medium of claim 11, wherein instructions for receiving information comprise instructions for receiving information via a communication interface.

13. The machine-readable storage medium of claim 12, wherein the communication interface comprises an Advanced Technology Attachment interface.

14. The machine-readable storage medium of claim 11, wherein the received information comprises information received in a sector register.

15. The machine-readable storage medium of claim 11, wherein instructions for receiving information comprise:
instructions for receiving information indicating that data stored on the self-encrypting storage device should be secured; and
instructions for receiving information indicating a method for securing data.
